(19) United States
(12) Patent Application Publication
(10) Pub. No.: US 2017/0299108 A1
(43) Pub. Date: Oct. 19, 2017

(54) FLEXIBLE PIG FOR PIPELINE MAINTENANCE

(71) Applicant: CURAPIPE SYSTEM LTD., ASHKELON (IL)

(72) Inventor: SAMUEL PERSTNEV, MERCAZ SHAPIRA (IL)

(21) Appl. No.: 15/512,849

(22) PCT Filed: Sep. 7, 2015
(86) PCT No.: PCT/IL2015/000040

§ 371 Date: Mar. 21, 2017

Related U.S. Application Data
(60) Provisional application No. 62/053,156, filed on Sep. 21, 2014.

(51) Int. Cl. F16L 55/44; B08B 9/055; F16L 101/40

(52) U.S. Cl. CPC F16L 55/44; B08B 9/0554; F16L 2101/40

(57) ABSTRACT

The present invention provides pipeline pigs for maintenance of a pipeline, the pig including two adjacent ovular sections generally symmetrically disposed about a vertical axis, a polymeric band disposed along the vertical axis, the band being adapted to reduce a cross section of the pig along the axis and a longitudinal inner support member disposed centrally along the ovular sections and perpendicularly to the vertical axis.

### FIELD OF THE INVENTION

The present invention relates generally to pipeline maintenance, and more specifically to pigs for relaying or batching materials to a remote location along a pipeline.

### BACKGROUND OF THE INVENTION

Many pipelines are constructed for long-distance transfer of fluids, such as water, petroleum, natural gas, crude oil and the like, from a source to a destination. The pipelines often corrode or accumulate deposits over time. Ideally, a pipeline should be straight, but often the terrain demands changes in diameter, cross-section, bends and different materials of construction. The maintenance of such pipelines is difficult. Moreover, leak/crack detection is difficult and leak/crack sealing may be very complex.

A number of devices have been developed for cleaning/maintaining pipelines.

GB1270378A describes a pipeline pig comprising a cylindrical body, having a core of soft, sponge-like, foamed plastic, an outer shell of relatively hard, sponge-like, foamed plastic, and, at the rear, an impermeable layer of un-foamed plastic forming a fluid-tight seal with the pipe. Both the core and the shell may be of foamed polyurethane, the core having a density of 1-10 pounds per cubic foot and the shell a density of 20-40 pounds per cubic foot. The body of the pig being permeable prevents its being contracted by the hydrostatic pressure in a pipe.

GB1444496A discloses a fluid-propelled pig for cleaning pipe-lines, the pig comprising a cylindrical sleeve member connected via radially extending disc-like members to an axial core the annular cavities so formed are filled with a foamed elastomer, e.g. polyurethane. In the embodiment shown, the sleeve member is flexible and either pervious or contains holes to render it such it has a length/diameter ratio greater than 1:5 to prevent cocking and the diameter is at least 4 times that of the core, which, together with disc-like members, is also flexible, preferably formed of a castable polyurethane. In the fluid, the pig provides a downstream spray via duct which extends from the upstream end of the pig to connect with outwardly extending ducts. An additional bore is provided to accommodate a towing ring. In an alternative embodiment (not shown) the sleeve, disc and core members are formed integrally the disc-like members-being conical offer a more unidirectional propulsion characteristic.

GB2229247A describes a pipe cleaning apparatus, such as a pig, which comprises a flexible (for example polyurethane) disc comprising radially extending cleaning fingers removably secured (e.g. by a bolt) to removable anchor pins connected to the disc (e.g. by a cross-pin) radially inboard of its periphery.

DE2136701B describes a pipeline pig, propelled through a pipe by pressure differential, comprising a cylindrical body of foamed plastics, e.g. polyurethane, with a flexible impervious plastics cover which completely covers one end of the body and has a portion for co-action with the body and the surrounding internal surfaces of the pipe to close the pipe against the flow of fluid past the body. The cover has openings through which, external areas of the cylindrical surface of the body is exposed, and has reinforcing e.g. fabric embedded therein.

DE2059083A discloses a cylindrical body of sponge-like material, which has a core of soft, flexible foamed plastics and a continuous core covering all over the body's periphery made of harder, more durable foamed plastics. Preferably a layer of flexible, impervious material covers one end of the body, for sealing engagement with a pipe wall. The pig is suitably “bullet” shaped.

JP2002192096A describes a solution to the problem of surely cleaning the wall surfaces within pipes by a pig, which smoothly travels in pipelines having different-diameter portions or the pipelines connected through quakeproof flexible pipes having large bore diameter in mid-way thereof. The invention provides a solution of a pig body of the pig for in-pipe cleaning, which is formed of a soft foam of 0.02 to 0.06 grams per cubic centimeter in foaming density and approximately the entire peripheral surface of the pig body is coated with a foam paste consisting of a foamed resin having shrinkability and flexibility equal to that of the soft foam and non-pressure fluid permeability at a thickness of 0.05 to 0.08 mm.

U.S. Pat. No. 5,895,619 sets forth both a method and apparatus for molding a unitary pig formed of two types of material, one being a lightweight foam, and the other being a harder polymeric material thereby yielding a unitary harder material in the cast pig. The finished product involves N discs having parallel end faces and a central drilled core; the unitary cast harder material defines end located discs located adjacent to said foam core and a central core therein so that the end located discs adjacent to the foam donut are unitary with the core and bonded thereto.

U.S. Pat. No. 5,924,158 describes a pipeline pig suitable for use in cleaning deposits and buildup from an interior surface in a pipeline, which is also particularly suited for applications wherein the pipeline has a series of bends, right angles or even plug headers. The pig is suitable for bidirectional travel, having front and rear hemispherical noses. The pig is constructed in a manner that facilitates a greater degree of elongation and deformation than is possible with known pipeline pigs, while still providing the radially outward bias that is required to effectively scrape the sidewalls of the pipeline. A cover carries a plurality of metal studs arrayed about the cylindrical middle portion, and encloses an internal core. The core is formed in a mold from a mixture of resin and ISO, resulting in a pig having superior ability to elongate and deform, if needed, while still effectively scraping the sidewalls of the pipeline.

U.S. Pat. No. 6,038,725 discloses a bendable, unicast pig formed of polyurethane. It has symmetrical front and rear end discs, seal discs there between and can wipe paraffin from a pipe. The body is devoid of intermediate discs to bend about 15 DEG or more.

U.S. Pat. No. 6,176,938 describes a pipeline evacuating device includes a first relatively rigid portion and a second relatively deformable portion. The deformable portion is arranged to be compressible against the rigid portion when the device is forced through a pipeline by the reaction of the material in the pipeline against the force of movement of the device. The compression causes the second portion to deform to at least substantially slidingly seal against the inside of the pipeline. Efficient evacuation of the material from the pipeline is provided as the device is forced therealong.

U.S. Pat. No. 6,500,271 describes a pipeline pig for removing scales and debris from the interior walls of a pipeline, which has a generally cylindrical central portion with a hollow core and a rounded end on each two ends of the cylindrical central portion, is produced of a flexible material to facilitate the movement of the pipeline pig through non-linear sections of a pipeline and buildups of scale and debris in a pipeline, has a solution which fills the hollow core, and includes a body which is formed as a peripheral fluid closed body composed of the flexible material.

Despite the teachings of the above-described publications, the prior art pigs are not optimally designed for the sealing of leaks in pipelines. There is thus an urgent need to provide pigs, sealing compositions and systems suited to this purpose.

### SUMMARY OF THE INVENTION

It is an object of some aspects of the present invention to provide a pig for maintaining pipelines, which is able to bend to accommodate turns, elbows and bends in the pipeline.

In some embodiments of the present invention, improved pipeline pigs are provided which can be maneuvered in a pipeline of changing cross-section. The changing cross section may be for example from a 2 inch to 3 inch to 4 inch diameter and vice versa. Moreover, the pipeline pig is constructed and configured to be maneuvered in a pipeline of varying cross section. The varying cross section may be, for example, circular to ovoid to elliptical and vice versa. Furthermore, the cross section may be asymmetrical due to the deposition of scale and other deposits.

In some embodiments of the present invention, improved pipeline pigs which can be maneuvered in a pipeline of changing cross-section are provided. In some embodiments of the present invention, improved pipeline pigs are provided which can be maneuvered through a fire hydrant of changing cross-section.

The present invention provides pipeline pigs for maintenance of a pipeline, each pig typically includes;
a. two adjacent ovular sections generally symmetrically disposed about a vertical axis;
b. a polymeric band disposed along the vertical axis, the band being adapted to reduce a cross section of the pig along the axis; and
c. a longitudinal inner support member disposed centrally along the ovular sections and perpendicularly to the vertical axis.

According to some other embodiments of the present invention, the pig may be asymmetric. The pigs of the present invention, are, according to some embodiments, constructed and configured to enter and/or be retrieved from a pipeline via any type of orifice or opening in the pipeline, existing or specially manufactured such as, but not limited to fire hydrants, air vents, hot taps and the like.

The pigs of the present invention are constructed and configured for use in a pig train (at least one pig and at least one substance disposed there-between, pigs or in front of a single pig) for relaying materials there-between, such as for general maintenance or any other future applications. The materials disposed in front of a pig or between pigs may be, for example, compositions and/or formulations disclosed in WO 2008/08441A1.

Additionally, according to an embodiment of the present invention, the pigs of the present invention are further adapted for standalone use, such as when a pig is applied such as in the case of a ‘swabbing’ pig for pipeline cleaning, etc. Furthermore, according to an embodiment of the present invention, the pigs may be used for short distance pigging such as in the case of pipe cleaning of distribution pipes.

According to an embodiment of the present invention, the pigs of the present invention are suitable for use for relaying/batching sealing materials/compositions to a variety of damaged sites in the pipeline, such as, but not limited to cracks, pinhole leaks, corroded sites and the like.

Furthermore, according to an embodiment of the present invention, the pigs of the present invention may comprise an internal active or passive transmitter/receiver (e.g. sonar) for measurements of placement and speed for control purposes of the pig/s.

Moreover, according to an embodiment of the present invention, the pigs are configured to support full bore enclose of sealing/curing material so they can address leaks of differing types at differing o-clocks (0-360 degrees), of which 12-o-clock orientation is most noteworthy.

Additionally, according to an embodiment of the present invention, when the pig train crosses a service line connection (or any other) which is leaking the batching configuration (pressure from the two pigs on the concentrated substance) enhances the occurrence of substance discharge into the service pipe which then flows toward leak creating a seal.

Moreover, according to an embodiment of the present invention, the pigs of the present invention may be used in a multi-train or multi-batching of products configuration; the purpose being to separate products.

Additionally, according to an embodiment of the present invention, a pig train of the present invention may be launched and retrieved through a fire hydrant or any general or special purpose orifice in the pipe.

Moreover, according to an embodiment of the present invention, the batching configuration of the pigs of the present invention is configured to enable retrieval of unused material in a one-batch retrieval process. In the water industry, this is useful for safety and quality purposes including environmental considerations, especially when maintenance materials are hazardous.

Additionally, according to an embodiment of the present invention, the batching configuration of the pigs (also when negotiating bends and changes in diameter) maintains levels of concentration of the encapsulated substance such that their effect is enhanced or as in our case increases the probability of sealing a leak.

The volume of substance between the pigs can be increased for example to reduce the outage time of the water mains. What is needed is a minimum exposure time of the leakage area to the substance as it passes over so that if the pig train speed is increased in order to reduce the outage time. The reduced exposure time of the leakage area can be compensated by increasing the volume of substance. Decreasing may be instrumental too in other ways so that this flexibility may be useful.

The pigs of the present invention can perform their function over a relatively wide range of pipe pressures.

Moreover, according to an embodiment of the present invention, the pigs of the present invention are relatively non-abrasive in their contact with the inner walls of ferrous pipes, thereby decreasing damage to tuberculation, encrustation and the like. This reduces the changes in the mineral content of water in the pipe, for example, and thereby reduces leaching of iron oxide (red water), alum, calcium carbonates, barium sulfide, or sediment, which may cause alarm amongst consumers and may affect the quality of the water.

There is thus provided according to an embodiment of the present invention, a pipeline pig for maintenance of a pipeline, the pig including;
a. two adjacent ovular sections generally symmetrically disposed about a vertical axis;
b. a polymeric band disposed along the vertical axis, the band being adapted to reduce a cross section of the pig along the axis; and
c. a longitudinal inner support member disposed centrally along the ovular sections and perpendicularly to the vertical axis.

Additionally, according to an embodiment of the present invention, the ovular sections each include a waterproof far end coating.

Furthermore, according to an embodiment of the present invention, the waterproof far end coating is adapted to cover at least a third of the length of the ovular section from the far ends.

Moreover, according to an embodiment of the present invention, the longitudinal inner support member is adapted to prevent compression along a horizontal axis.

Further, according to an embodiment of the present invention, the ovular sections each include an indented nose end.

Yet further, according to an embodiment of the present invention, the indented nose end includes four triangular inwardly sloping sides.

Additionally, according to an embodiment of the present invention, the ovular sections each include at least one centrally disposed vertical support member.

Moreover, according to an embodiment of the present invention, the at least one centrally disposed vertical support member are annular and are disposed around the longitudinal inner support member.

Furthermore, according to an embodiment of the present invention, the pig is deformable about both a vertical and a horizontal axis.

Additionally, according to an embodiment of the present invention, the pig is compressible about both a vertical and a horizontal axis.

Moreover, according to an embodiment of the present invention, the ovular sections can be deformed to form generally spherical sections.

Further, according to an embodiment of the present invention, the polymeric band is a rubber band.

Yet further, according to an embodiment of the present invention, the ovular sections include an outer polymeric shell.

Additionally, according to an embodiment of the present invention, the ovular sections include at least one inner polymeric support member.

Furthermore, according to an embodiment of the present invention, the outer polymeric shell includes expanded polyurethane.

Additionally, according to an embodiment of the present invention, the expanded polyurethane has a density in a range of 3-25 kg/m³.

Moreover, according to an embodiment of the present invention, the expanded polyurethane has a density in a range of 5-20 kg/m³.

Further, according to an embodiment of the present invention, the at least one inner polymeric support member includes polyurethane of a density in a range of 20-60 kg/m³.

Additionally, according to an embodiment of the present invention, the at least one inner polymeric support member includes at least one longitudinal polymeric support member of polyurethane of a density in a range of 20-140 kg/m³.

Furthermore, according to an embodiment of the present invention, the pig is deformable but substantially not liquid permeable along a pipeline of an increase in 100% of a diameter thereof.

Additionally, according to an embodiment of the present invention, the pig is deformable but substantially not liquid permeable along a pipeline of a decrease in 100% of a diameter thereof.

Moreover, according to an embodiment of the present invention, wherein the longitudinal inner support member is adapted to prevent compression along a horizontal axis.

Additionally, according to an embodiment of the present invention, the pig is deformable from 180 to around 40 degrees along a horizontal axis.

Furthermore, according to an embodiment of the present invention, the longitudinal inner support member is further adapted to prevent mixing of a fluid upstream of the pig with fluid downstream of the pig.

Importantly, according to an embodiment of the present invention, the pig is constructed and configured to pass from a pipeline of a first larger diameter to a pipeline of a second smaller diameter without increasing the pig horizontal cross-section.

Additionally, according to an embodiment of the present invention, the pig is constructed and configured to pass from a pipeline of a first smaller diameter to a pipeline of a second larger diameter.

The present invention will be more fully understood from the following detailed description of the preferred embodiments thereof, taken together with the drawings.

### BRIEF DESCRIPTION OF THE DRAWINGS

The invention will now be described in connection with certain preferred embodiments with reference to the following illustrative figures so that it may be more fully understood.

With specific reference now to the figures in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1A is a simplified schematic illustration of a pipeline pig, in accordance with an embodiment of the present invention;

FIG. 1B is a simplified schematic flow chart of a method for preparing a pig, in accordance with an embodiment of the present invention;

FIG. 2A is a simplified schematic illustration showing a cross-section of a pipeline pig along line A-A in FIG. 1, in accordance with an embodiment of the present invention;

FIG. 2B is a simplified schematic illustration showing a cross-section of a pipeline pig along line B-B in FIG. 1, in accordance with an embodiment of the present invention;

FIG. 2C is a simplified schematic illustration showing a cross-section of a pipeline pig along line C-C in FIG. 1, in accordance with an embodiment of the present invention;

FIG. 3A is a simplified schematic illustration showing a top end view of a pipeline pig, in accordance with an embodiment of the present invention;

FIG. 3B is a simplified schematic illustration showing a perspective end view of a pipeline pig, in accordance with an embodiment of the present invention;

FIG. 4A is a simplified schematic illustration showing a vertical cross section of a pipeline pig, in accordance with an embodiment of the present invention;

FIG. 4B is a simplified schematic illustration showing a partial vertical cross section of a pipeline pig, in accordance with another embodiment of the present invention;

FIG. 5A is a simplified schematic illustration showing a side view of a pipeline pig without any forces applied thereto, in accordance with an embodiment of the present invention;

FIG. 5B is a simplified schematic illustration showing a side view of a pipeline pig with a first set of side forces applied thereto, in accordance with an embodiment of the present invention;

FIG. 5C is a simplified schematic illustration showing a side view of a pipeline pig with a second set of side forces applied thereto, in accordance with an embodiment of the present invention;

FIG. 6A is a simplified schematic illustration showing a side view of a pipeline pig with a first set of end forces applied thereto, in accordance with an embodiment of the present invention;

FIG. 6B is a simplified schematic illustration showing a side view of a pipeline pig without any end forces applied thereto, in accordance with an embodiment of the present invention;

FIG. 6C is another simplified schematic illustration showing a side view of a pipeline pig with a first set of end forces applied thereto, in accordance with an embodiment of the present invention;

FIG. 6D is a simplified schematic illustration showing a side view of a pipeline pig with a second set of end forces applied thereto, in accordance with an embodiment of the present invention;

FIG. 7 is a simplified schematic illustration showing a vertical cross section of another pipeline pig, in accordance with an embodiment of the present invention;

FIG. 8 is a simplified schematic illustration showing a longitudinal inner support member, in accordance with an embodiment of the present invention; and

FIG. 9 is a simplified pictorial flow chart of a method for preparing a pig, in accordance with an embodiment of the present invention.

In all the figures similar reference numerals identify similar parts.

### DETAILED DESCRIPTION OF PREFERRED EMBODIMENTS

In the detailed description, numerous specific details are set forth in order to provide a thorough understanding of the invention. However, it will be understood by those skilled in the art that these are specific embodiments and that the present invention may be practiced also in different ways that embody the characterizing features of the invention as described and claimed herein.

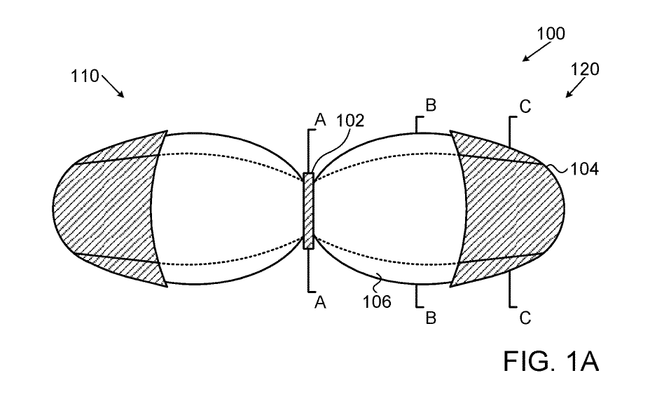

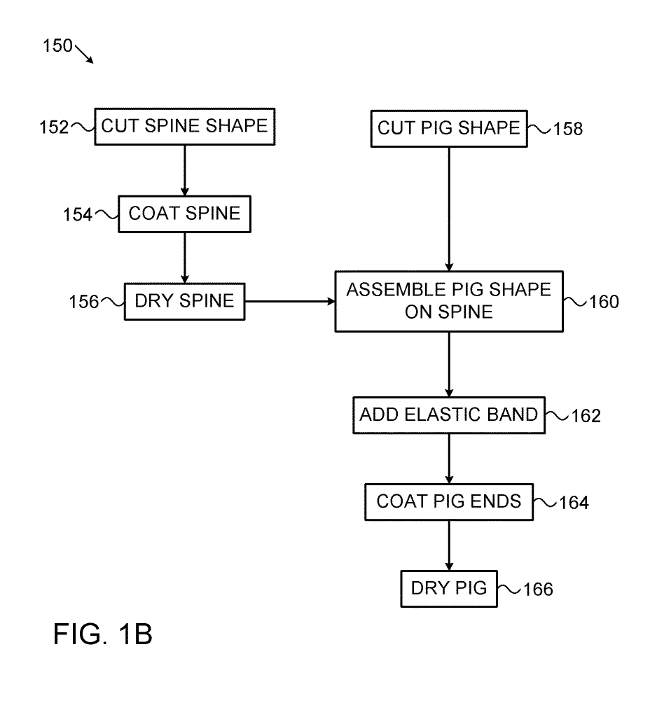

Reference is now made to FIG. 1, which is a simplified schematic illustration of a pipeline pig 100, in accordance with an embodiment of the present invention.

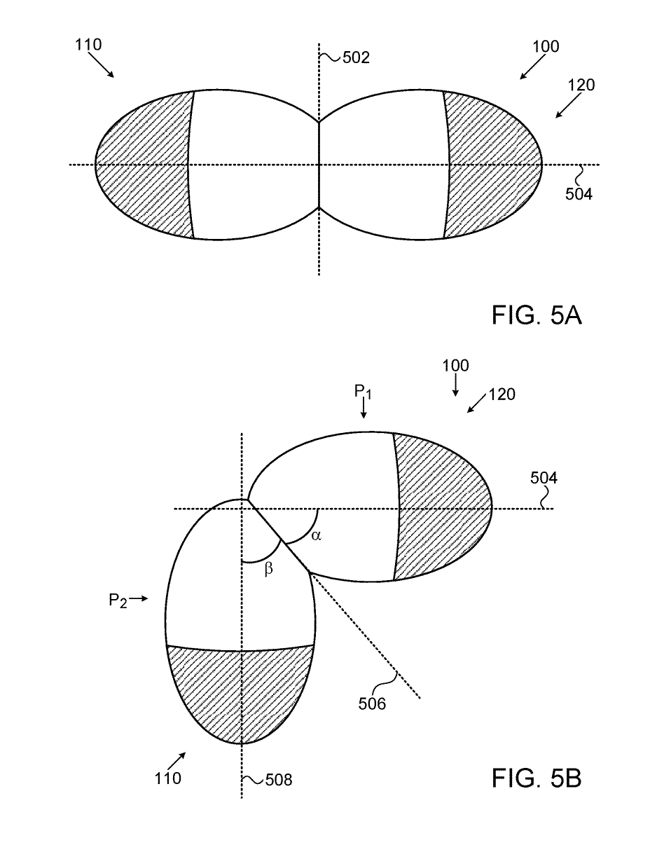

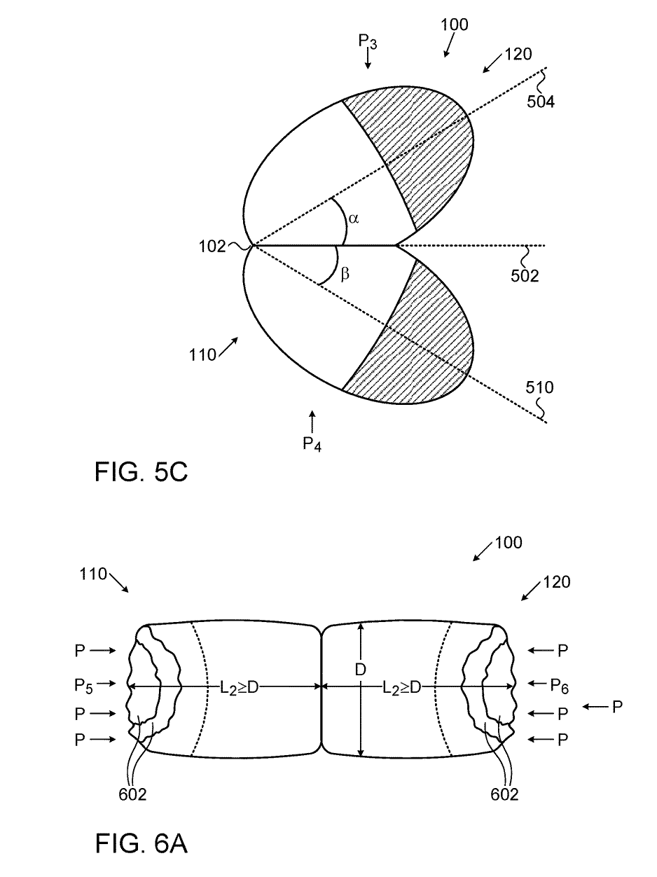

Pig 100 comprises two centrally connected roughly-ovular (egg-shaped) sections 110, 120. A polymeric band 102, such as a rubber band, reduces the cross section of the pig along a vertical axis 502 (FIG. 5A). The pig is generally symmetrical about vertical axis 502. Each ovular section comprises at a waterproof far end coating 104. According to one embodiment the waterproof coating comprises POLYGAG™ (TAMBOUR LTD., P.O. Box 8488 Kiryat Sapir Industrial Park, South Netanya, ISRAEL). The ovular sections 110, 120 comprise a body of an expanded polymer 106, such as polyurethane (density range 3-18 kg/m³), though other alternative materials known in the art could be used.

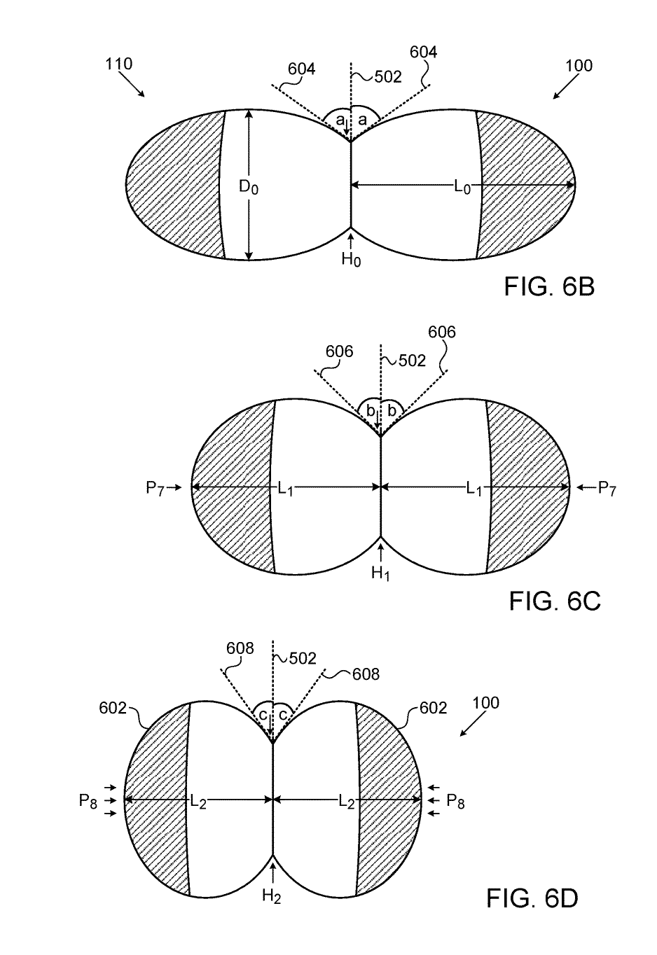

In some embodiments, the pig has a length (2×L₀, FIG. 6B) of around 27-30 cm and a width of 8-11 cm (D₀, FIG. 6B). In one embodiment, the length is 28.5 cm and the width is 9.5 cm.

According to some embodiments of the present invention, the pigs described herein are of similar geometries, but of different dimensions, which are matched to the pipe dimensions, in which they are used.

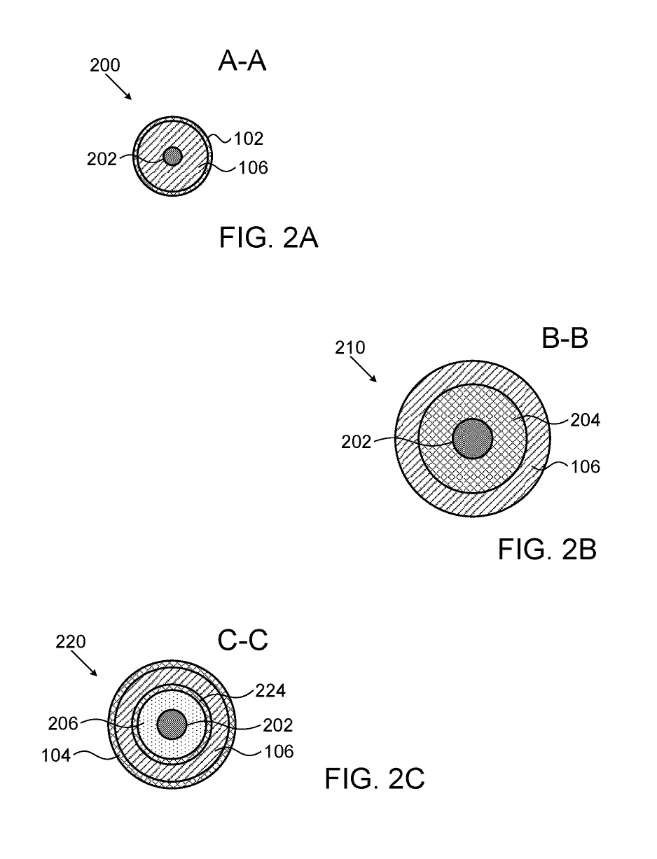

Reference is now made to FIG. 2A, which is a simplified schematic illustration showing a cross-section 200 of a pipeline pig along line A-A in FIG. 1, in accordance with an embodiment of the present invention.

Cross section 200 shows three layers, an outer rubber band layer 102, an expanded polymer layer 106 and a longitudinal inner support member 202, which typically extends along the entire length (2×L₀) of the pig. The inner support member 202 may be constructed of a dense polymer, such as expanded polyurethane (60 kg/m³). Alternative materials of construction known in the art are deemed to be within the scope of the present invention.

Reference is now made to FIG. 1B, which is a simplified schematic flow chart 150 of a method for preparing a pig, in accordance with an embodiment of the present invention.

In a first spine preparation step 152, a spine (also termed herein a longitudinal inner support member 202) is cut from a dense polymeric material, such as expanded polyurethane (60 kg/m³). According to one embodiment, its shape comprises four long sides 802, typically of a square or rectangular cross section. At each end 809 each side has a triangular end 808. In between each triangular end there is a trapezoid face 806. Four trapezoid shapes form a horizontal rhomboid end face 812 (FIG. 8).

According to another embodiment, the ends are conical.

According to another embodiment, the ends are pyramidal.

In a spine coating step 154, the longitudinal inner support member is coated with a waterproof coating, such as, but not limited to, POLYGAG™ (TAMBOUR LTD., P.O. Box 8488 Kiryat Sapir Industrial Park, South Netanya, ISRAEL).

The spine is then air dried in a spine drying step 156.

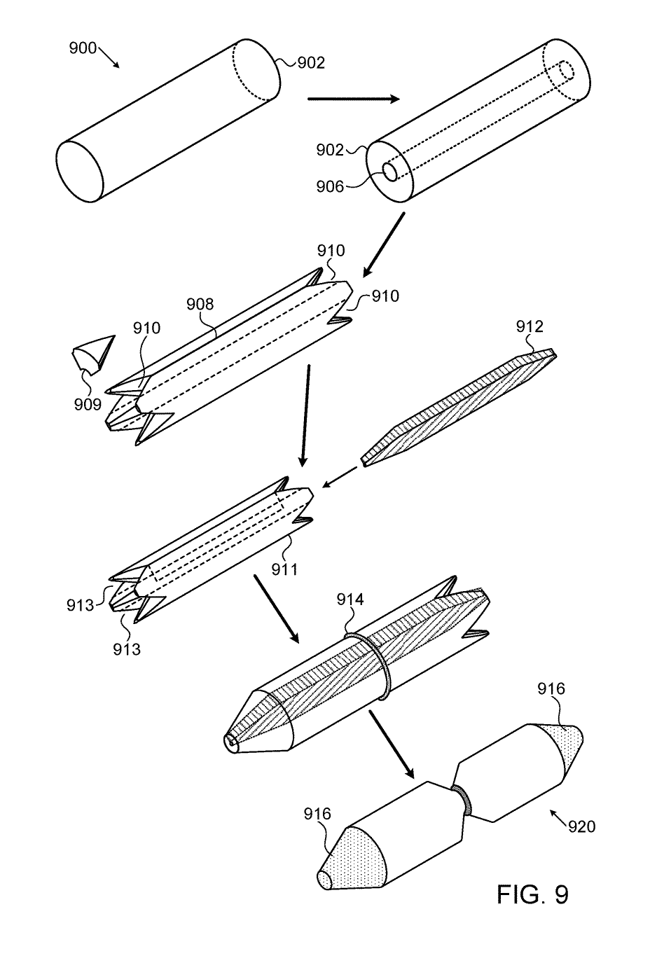

In a cutting pig shape step 158, a cylindrical section of an expanded polymer is cut. This is shown and described in further detail in FIG. 9.

In an assembling step 160 the cut pig shape 911 (FIG. 9) is assembled on the spine. It may be glued, heat welded or otherwise affixed to the spine.

It should be understood that there are many variations in the steps of this methodology, and many different variations and permutations in the shape of the pigs. This flowchart should not be deemed as limiting. The cut pig shape 911 (FIG. 9) is shown in greater detail in FIG. 9.

In an adding elastic step 162 an elastic band 102 (FIG. 1) is added over a central horizontal axis of the cut pig shape 911 (FIG. 9).

The pig ends are coated in a water resistant or water-proof coating, such as POLYGAG™ (TAMBOUR LTD., P.O. Box 8488 Kiryat Sapir Industrial Park, South Netanya, ISRAEL).

In a drying step 166, the water proof coating is allowed to dry. The pig is then ready for use.

Reference is now made to FIG. 2B, which is a simplified schematic illustration showing a cross-section 210 of pipeline pig 100 along line B-B in FIG. 1, in accordance with an embodiment of the present invention.

In this cross-section, three layers are seen. An outer expanded polymer layer 106, a middle vertical support member 204 mounted around the inner support member 202. Vertical support member 204 may be of an annular ring shape and constructed of a polymer such as expanded polyurethane (density 20 kg/m³). There is typically one vertical support member 204 placed centrally in each of ovular sections 110, 120. Vertical support member may have a width of around 0.5-3 cm.

Reference is now made to FIG. 2C, which is a simplified schematic illustration showing a cross-section 220 of pipeline pig 100 along line C-C in FIG. 1, in accordance with an embodiment of the present invention.

An outer layer comprises far end coating 104, which seals expanded polymer layer 106. Inside expanded polymer layer 106, there may be an inner waterproof layer 224. Inside the inner waterproof layer 224 there is a second expanded polymer layer 206. In some cases, layer 206 may be replaced by air 208 (not shown). Additionally, inside layer 206 is the centrally disposed inner support member 202.

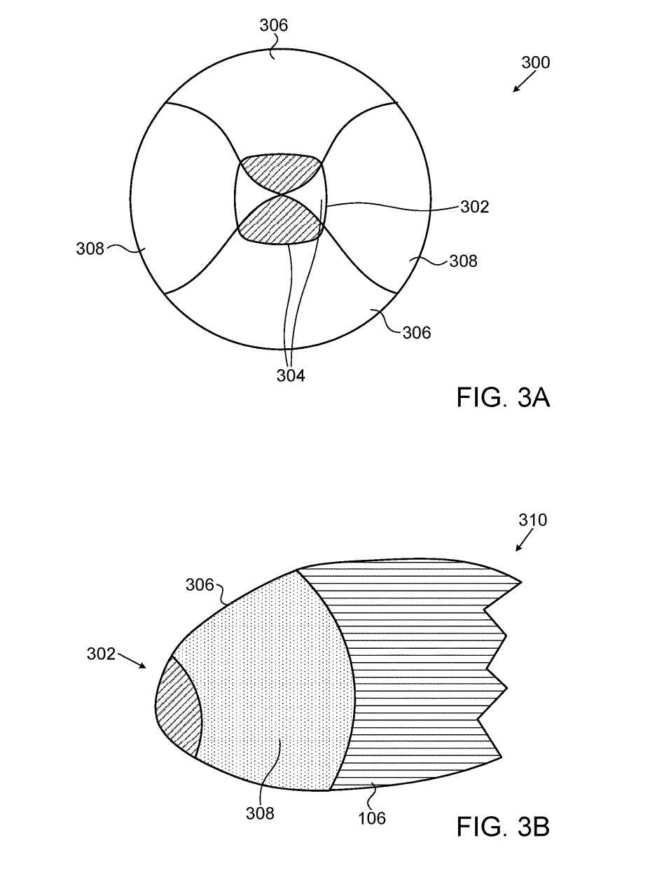

Reference is now made to FIG. 3A, which is a simplified schematic illustration showing a top end view 300 of pipeline pig 100, in accordance with an embodiment of the present invention.

In some embodiments, the pipeline pig has an indented nose end 302. The nose end may, in some examples comprise four triangular inwardly sloping sides 304. These sides may each be of a generally triangular shape, for example. Around the indented nose there are disposed four end sections, two vertically disposed sections 308 and two horizontally disposed sections 306. These sections may form a substantially circular cross section of diameter D₀ at a far end. The indented nose may have an exterior diameter of 3-5 cm, for example.

Turning to FIG. 3B, there is seen a simplified schematic illustration showing a perspective end view 310 of a pipeline pig, in accordance with an embodiment of the present invention.

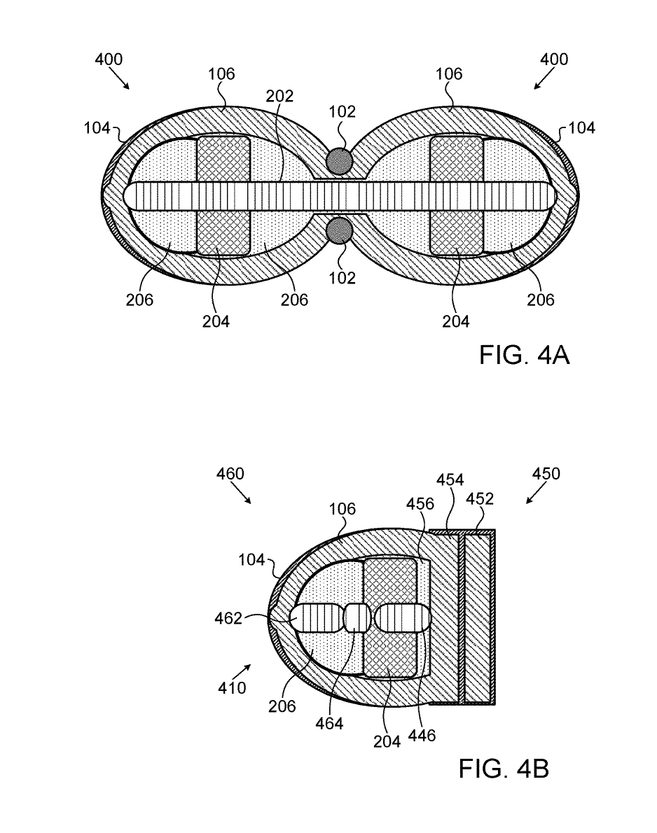

Reference is now made to FIG. 4A, which is a simplified schematic illustration showing a vertical cross section 400 of an alternative pipeline pig 400, in accordance with an embodiment of the present invention. Pig 400 does not have an indented nose end 302, whereas pig 100 does. The relative sizes of the layers are well depicted in this figure.

Turning to FIG. 4B, there is seen is a simplified schematic illustration showing a partial vertical cross section 450 of a pipeline pig 460, in accordance with another embodiment of the present invention. As can be seen in the figure, several features differ in pig 460 from pig 100. In pig 460, there is a vertically disposed central support disc 452 and no polymeric band 102. Pig 460 also comprises two ovular sections 410 (shown), 420 (not shown). In pig 460, there is no central support member 202, but rather a number of centrally disposed support members 462, 464, 466. The support members may also be constructed of a dense polymer, such as expanded polyurethane (60 kg/m³). Pig 460 also comprises expanded polymer layers 206, waterproof far end coating 104 and inner waterproof layer 224. Pig 460 may also comprise support members 204, 254, which may be constructed of the same or different materials.

Some of the advantages of the construction of the pigs of the present invention are now described with reference to FIGS. 5A-6D.

Reference is now made to FIG. 5A, which is a simplified schematic illustration showing a side view of pipeline pig 100 without any forces applied thereto, in accordance with an embodiment of the present invention. Pig 100 is generally symmetrical about vertical axis 502 and horizontal axis 504, with both ovular sections being disposed adjacent one to the other along axis 504.

FIG. 5B is a simplified schematic illustration showing a side view of a pipeline pig 100 with a first set of side forces applied thereto, in accordance with an embodiment of the present invention.

Upon applying a side pressure P₁, generally perpendicular to axis 504 and a different pressure P₂ generally parallel to axis 502, the pig is deformed moving ovular section 110 about a bend, thereby forming an angle (α+β), as shown in the figure, between axes 504 and 506 and 506 and 508 respectively. In some cases, α+β may be an obtuse angle, in other cases, this may be 90 degrees.

Reference is now made to FIG. 5C, which is a simplified schematic illustration showing a side view of a pipeline pig 100 with a second set of side forces applied thereto, in accordance with an embodiment of the present invention. In this case the pressures applied are P₃ and P₄, which are both greater in magnitude that P₁ and P₂. The angle formed between ovular sections 120 and 110 is now (γ+δ), between axes 504, 512 and 512, 510 respectively. This angle (γ+δ) is smaller in magnitude than (α+β). It should be understood that P₁ and P₂ may/may not be identical and likewise P₃ and P₄ may/may not be identical. Thus angles α and β may/may not be identical and γ and δ may/may not be identical.

FIG. 6A shows a simplified schematic illustration showing a side view of pipeline pig 100 with a first set of end forces applied thereto, in accordance with an embodiment of the present invention.

When pressures P5 and P6 are applied to ovular sections 110 and 120, respectively, the ovular sections deform and the lengths of the ovular sections are reduced from L₀ (FIG. 6B) to L₂. The pressure forces applied form wrinkles 602 to end sections 308, 306. Pig 100 is constructed and configured to maintain a length of the ovular section greater or equal to its width D. This is further described in the ensuing figures.

Turning to FIG. 6B, there is seen is a simplified schematic illustration showing a side view of a pipeline pig without any end forces applied thereto, in accordance with an embodiment of the present invention. Ovular sections are pinched in by band 102, thereby forming and angle a between vertical axis 502 and a side axis 604.

Reference is now made to FIG. 6C, which is another simplified schematic illustration showing a side view of a pipeline pig with a first set of end forces applied thereto, in accordance with an embodiment of the present invention. Upon applying a small force at pressure P₇, the length of the ovular sections is reduced to L₁. Simultaneously the angle formed between the vertical axis 502 along rubber band 102 and a side of the polyurethane body 106 on axis 606 is now b, which is smaller than angle a. Concurrently the height of the rubber band may increase from H₀ (FIG. 6B) to H₁ (FIG. 6C).

Referring now to FIG. 6D, a simplified schematic illustration is seen showing a side view of a pipeline pig with a second set of end forces applied thereto, in accordance with an embodiment of the present invention.

Upon applying a greater force than at pressure P₇, namely, pressure P₈, the length of the ovular sections is further reduced to L₂. Simultaneously the angle formed between the vertical axis 502 along rubber band 102 and a side of the polyurethane body 106 on axis 608 is now c, which is smaller than angle b. Concurrently the height of the rubber band may increase from H₁ (FIG. 6C) to H₂ (FIG. 6D).

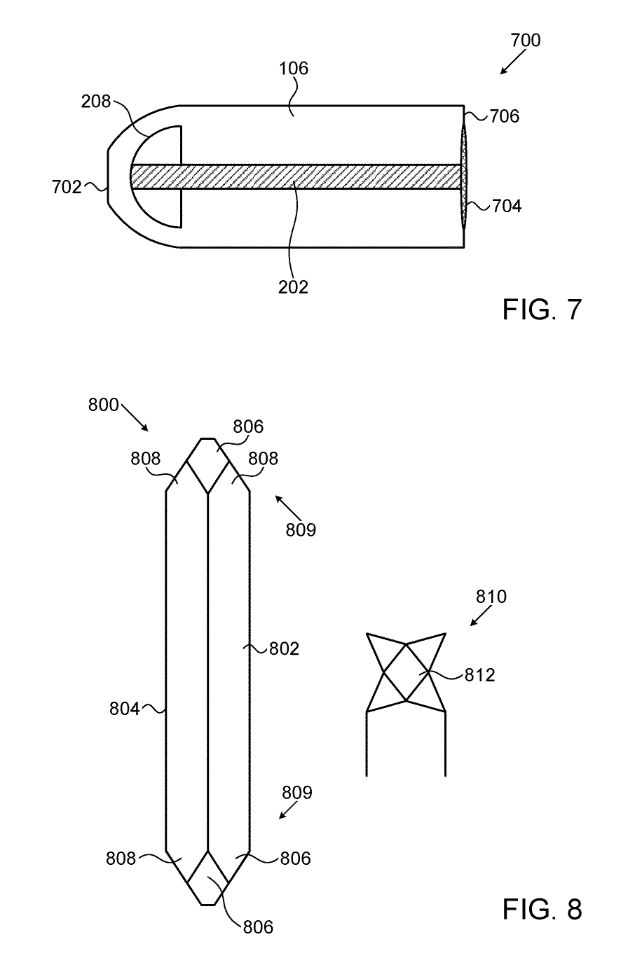

Finally, we turn to FIG. 7, which is a simplified schematic illustration showing a vertical cross section of another pipeline pig 700, in accordance with an embodiment of the present invention.

Pipeline pig 700 comprises a longitudinal inner support member 202 surrounded by expanded polymer layer 106. This pig has a flat nose 702 and an air space 208 at the anterior end. At a posterior end 704, there may be a flat surface 706 or a concave surface 708 (not shown).

These figures show how the pipeline pigs 100, 400, 450, 700 of the present invention may be deformed along a longitudinal and horizontal axis without allowing significant passage of fluids from one side of the pig to another side of the pig. Thus the pigs of the present invention are constructed and configured to be maneuvered along non-linear pipelines for the cleaning, sealing and maintenance thereof.

FIG. 8 is a simplified schematic illustration showing a longitudinal inner support member 900, in accordance with an embodiment of the present invention; and is described in further detail hereinabove.

Turning to FIG. 9, there is seen a simplified pictorial flow chart 900 of a method for preparing a pig, in accordance with an embodiment of the present invention. A cylindrical foam shape 902 is cut to form a central hollow annulus 906 extending along its length to form a hollow cylinder 904. The foam shape may be opened along an opening 908 on its longitudinal axis.

Thereafter four triangular sections (wedge-shaped sections) 909 are cut out of each end of the hollow cylinder 904 to form cut outs 910. A longitudinal inner support member 202 is introduced to the hollow and the cutouts are glued with glue 913 to the spine. An elastic band 914 is added to the center of cut pig shape 911. The ends of the cut pig shape 911 are then coated with a waterproof coating 916 and a pig 920 is then ready for use.

The pigs of the present invention are further constructed and configured to be maneuvered along bends in pipelines for the cleaning, sealing and maintenance thereof. The pigs of the present invention are further constructed and configured to be maneuvered along pipelines of increasing/decreasing diameters without allowing fluids to pass from an upstream side of the pig to a downstream side of the pig, or vice versa.

The pigs of the present invention are further constructed and configured to be maneuvered along pipelines of increasing/decreasing diameters without significantly increasing a cross-sectional diameter of the ovular section beyond its original diameter.

The pigs of the present invention are further constructed and configured to be maneuvered around bends in pipelines without significantly increasing a cross-sectional diameter of the ovular section beyond its original diameter.

The references cited herein teach many principles that are applicable to the present invention. Therefore the full contents of these publications are incorporated by reference herein where appropriate for teachings of additional or alternative details, features and/or technical background.

It is to be understood that the invention is not limited in its application to the details set forth in the description contained herein or illustrated in the drawings. The invention is capable of other embodiments and of being practiced and carried out in various ways. Those skilled in the art will readily appreciate that various modifications and changes can be applied to the embodiments of the invention as hereinbefore described without departing from its scope, defined in and by the appended claims.

1-31. (canceled)

32. A pipeline pig for maintenance of a pipeline, the pig comprising:
a. two adjacent ovular sections generally symmetrically disposed about a vertical axis;
b. a polymeric band disposed along said vertical axis, said band being adapted to reduce a cross section of said pig along said axis; and
c. a longitudinal inner support member disposed centrally along said ovular sections and perpendicularly to said vertical axis.

33. A pipeline pig according to claim 32, wherein said ovular sections each comprise a waterproof far end coating.

34. A pipeline pig according to claim 33, wherein said waterproof far end coating is adapted to cover at least a third of the length of the ovular section from the far ends.

35. A pipeline pig according to claim 32, wherein said longitudinal inner support member is adapted to prevent compression along a horizontal axis.

36. A pipeline pig according to claim 32, wherein said ovular sections each comprise an indented nose end.

37. A pipeline pig according to claim 32, wherein said indented nose end comprises four triangular inwardly sloping sides.

38. A pipeline pig according to claim 35, wherein said ovular sections each comprise at least one centrally disposed vertical support member.

39. A pipeline pig according to claim 38, wherein said at least one centrally disposed vertical support member are annular and are disposed around said longitudinal inner support member.

40. A pipeline pig according to claim 32, wherein said pig is deformable about both a vertical and a horizontal axis.

41. A pipeline pig according to claim 32, wherein said ovular sections can be deformed to form generally spherical sections.

42. A pipeline pig according to claim 32, wherein said polymeric band is a rubber band.

43. A pipeline pig according to claim 32, wherein said ovular sections comprise an outer polymeric shell.

44. A pipeline pig according to claim 43, wherein said ovular sections comprise at least one inner polymeric support member.

45. A pipeline pig according to claim 44, wherein said outer polymeric shell comprises expanded polyurethane.

46. A pipeline pig according to claim 46, wherein said expanded polyurethane has a density in a range of 3-25 kg/m3.

47. A pipeline pig according to claim 45, wherein said at least one inner polymeric support member comprises polyurethane of a density in a range of 20-160 kg/m3.

48. A pipeline pig according to claim 47, wherein said at least one inner polymeric support member comprises at least one longitudinal polymeric support member of polyurethane of a density in a range of 20-140 kg/m3.

49. A pipeline pig according to claim 32, wherein said pig is deformable but substantially not liquid permeable along a pipeline of an increase in 100% of a diameter thereof.

50. A pipeline pig according to claim 32, wherein said pig is deformable but substantially not liquid permeable along a pipeline of a decrease in 100% of a diameter thereof.

51. A pipeline pig according to claim 32, wherein said longitudinal inner support member is adapted to prevent compression along a horizontal axis.
